(19) United States
(12) Patent Application Publication
(10) Pub. No.: US 2021/0129209 A1
(43) Pub. Date: May 6, 2021

(54) METHOD FOR MAKING SOCKET AND PAWL OF RATCHET

(71) Applicant: Chao-Chih Liu, Taichung City (TW)

(72) Inventor: Chao-Chih Liu, Taichung City (TW)

(21) Appl. No.: 16/669,522

(22) Filed: Oct. 31, 2019

(51) Int. Cl. B21K 5/16; B23P 15/00

(52) U.S. Cl. CPC B21K 5/16; B25B 13/463; B23P 15/00

(57) ABSTRACT

A method for making a socket and a pawl of a ratchet wrench includes a step of preparing: preparing a socket and a pawl; a step of first treatment: making the socket to have a body, a reinforcement portion and a driving hole, the driving hole defined axially through the body and having an axis, multiple ridges extending axially and inward from the inner periphery of the driving hole, the body having outer teeth formed on the outer periphery thereof, the reinforcement portion being an annular portion and formed along one of two ends of the body, the socket being treated by way of forging, the pawl having a toothed portion and a recess, the toothed portion engaged with the outer teeth of the socket, the pawl being made by way of metal injection molding, and a step of secondary treatment: polishing the socket and the pawl.

### BACKGROUND OF THE INVENTION

### 1. Fields of the Invention

The present invention relates to a method for making a socket and a pawl of a ratchet wrench so as to minimize manufacturing tolerances.

### 2. Descriptions of Related Art

The conventional torque wrenches include a damper unit received therein which has a pre-set torque value so that when the wrench reaches the pre-set torque value, the damper unit generates a sound to acknowledge the users so as to protect the object to be tightened. The ratchet wrench is cooperated with a socket 10 as shown in FIGS. 7 and 8 to output torque to an object. The socket 10 includes a through hole 101 which is a round hole and multiple ridges 102 and grooves 103 are formed in an inner periphery of the through hole 101. The socket 10 includes outer teeth 104 formed on the outer surface of the socket 10. The socket 10 is usually made by way of heat forging, however, the heat forging may cause manufacturing tolerance between the ridges 102 and the grooves 103. In other words, the thickness of the socket 10 and the roundness change during the heat forging of the socket 10.

Besides, the pawl used in the ratchet wrench includes a toothed portion which is engaged with the outer teeth 104 of the socket 10, and the hardness of the pawl has to he high enough so as to drive the socket 10 to output the torque force to tighten or loosen an object. The methods for making the pawl is cold forging, hot forging and warm forging. Then cold pressing is applied to the pawls to form the desired shape of the pawl. Nevertheless, the time required for making the pawls is long and is not efficient. The latest method is powder metallurgy, however, the density of the pawls is low so that the pawls may not be able to output sufficient torque.

The present invention is intended to provide a method for making a socket with minimize manufacturing tolerances, and a pawl with higher hardness to eliminate the drawbacks mentioned above.

### SUMMARY OF THE INVENTION

The present invention relates to a method for making a socket and a pawl of a ratchet wrench and comprising:

a step of preparing: preparing a socket and a pawl;

a step of first treatment: making the socket to have a body, a reinforcement portion and a driving hole, the driving hole defined axially through the body and having an axis, multiple ridges extending axially and inward from the inner periphery of the driving hole, the body having outer teeth formed on the outer periphery thereof, the reinforcement portion being an annular portion and formed along one of two ends of the body, the socket being treated by way of forging, the pawl having a. toothed portion and a recess, the toothed portion engaged with the outer teeth of the socket, the pawl being made by way of metal injection molding, and

a step of secondary treatment: polishing the socket and the pawl.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method of the present invention;

FIG. 2 is a perspective view to show the socket made by the method of the present invention;

FIG. 3 is another perspective view to show the socket made by the od of the present invention;

FIG. 4 is a perspective view, partially removed, of the socket made by the method of the present invention;

FIG. 5 is a cross sectional view of the socket made by the method of the present invention;

FIG. 6 is an exploded view of a ratchet wrench with the socket and the pawl made by the method of the present invention;

FIG. 7 is a perspective view to show the conventional socket, and

FIG. 8 is a cross sectional of the conventional socket.

### DETAILED DESCRIPTION OF THE PREFERRED EMBODIMENT

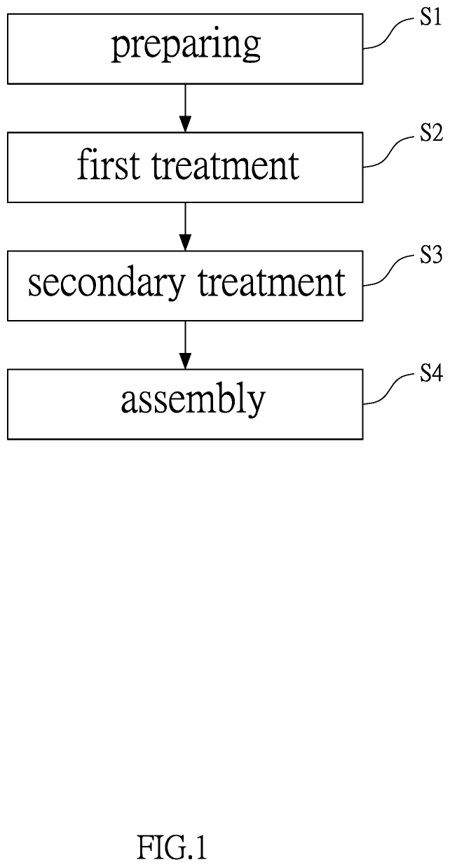

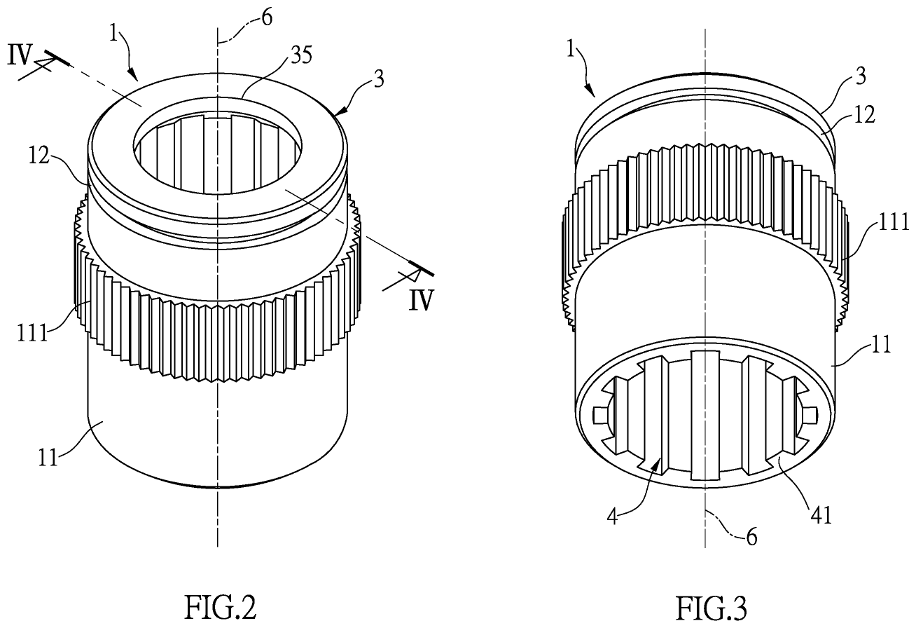

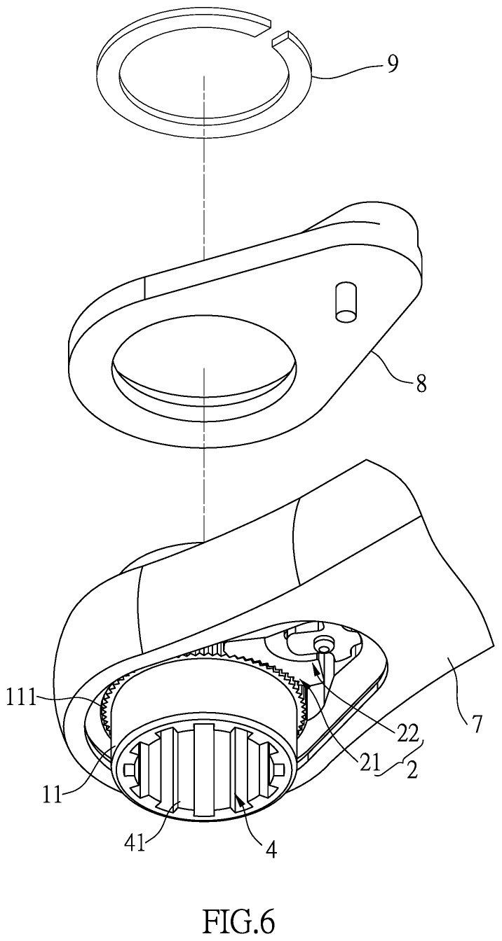

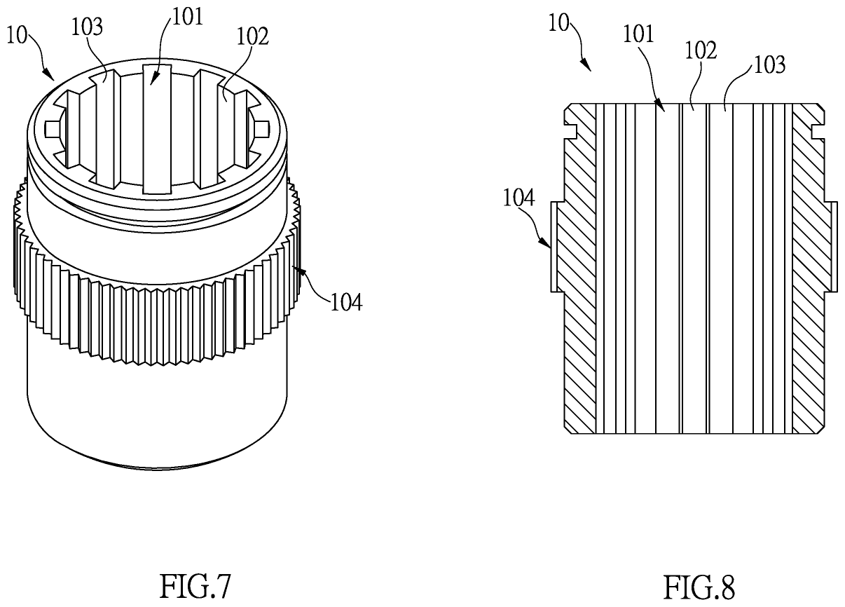

Referring to FIGS. 1 to 6, the method for making a socket and a pawl of a ratchet wrench of the present invention comprises the following steps:

a step of preparing S1: preparing a socket 1 with a through hole defined axially therethrough, and a pawl 2;

a step of first treatment S2: making the socket 1 to have a body 11, a reinforcement portion 3 and a driving hole 4;

a step of secondary treatment S3: polishing the socket 1 and the pawl 2, and

a step of assembly S4: assembling the pawl 2 in a ratchet wrench.

The driving hole 4 is defined axially through the body 11 and includes an axis 6. Multiple ridges 41 extend axially and inward and are evenly spaced from the inner periphery of the driving hole 4. The body 11 is a tubular body and has outer teeth 111 formed on the outer periphery thereof. The reinforcement portion 3 is an annular portion and formed along one of two ends of the body 11. The socket 1 is treated by way of forging. It is noted that the reinforcement portion 3 is an annular portion which is formed on one of the two ends of the body 11 of the socket 1 so as to limit deformation of the socket 1 during manufacturing, such that the manufacturing tolerances of the socket 1 can be minimized.

The pawl 2 includes a toothed portion 21 and a recess 22 respectively formed in two ends thereof. The toothed portion 21 is defined in a recessed area of the front end of the pawl 2, and the recess 22 is formed in the rear end of the pawl 2. The toothed portion 21 of the pawl 2 is engaged with the outer teeth 111 of the socket 1. The pawl 2 is made by way of metal injection molding, powder injection molding or Ceramic injection molding. The metal powders are smaller than those used in the conventional powder metallurgy so that: the pawl 2 has higher density to bear high torque.

Specifically, the reinforcement portion 3 includes an outside face 31, an inside face 32 and a top face 33 which is formed between the outside face 31 and the inside face 32. A first thickness “H” is defined between the outside face 31 of the reinforcement portion 3 and the inside face 32 of the reinforcement portion 3 as shown in FIG. 5. A second thickness “h” is defined between the distal face of each ridge 41 and the outer periphery of the body 11 of the socket 1. The outside face 31 of the reinforcement portion 3 is in flush with the outer periphery of the body 11 of the socket 1. The first thickness “H” is larger than the second thickness “h”. Because the first thickness “H” is larger than the second thickness “h”, so that the deformation of the reinforcement portion 3 is properly limited and is smaller than the deformation of the body 11. By this arrangement, the manufacturing tolerances of the socket 1 will be limited by the reinforcement portion 3 and can be minimized.

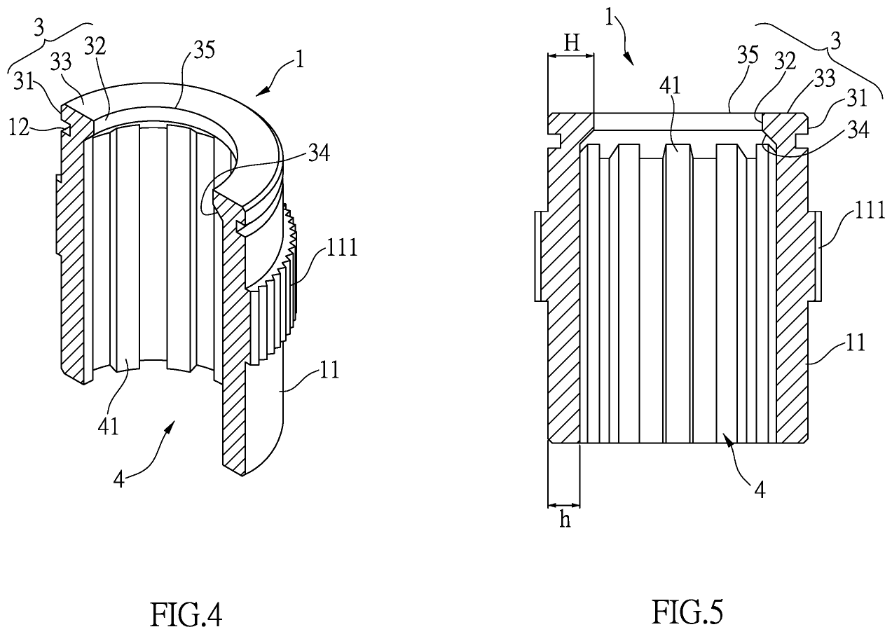

The inside face 32 of the reinforcement portion 3 communicates with the driving hole 4 and located at one end of the socket 1. An inclined face 34 is formed between the inside face 32 of the reinforcement portion 3 and the inner periphery of the driving hole 4. An opening 35 is formed within the reinforcement portion 3 due to the inclined face 34 as shown in FIGS. 4 and 5, the opening 35 is located to share the axis 6 of the driving hole 4 as the axis of the opening 35. The diameter of the opening 35 is smaller than that of the driving hole 4.

A groove 12 is formed in the outer periphery of the body 11 of the socket 1 and located between the outside face 31 of the reinforcement portion 3 and the outer periphery of the body 11 of the socket 1. The depth of the groove 12 in the radial direction of the socket 1 is smaller than the first thickness “H”.

The pawl 2 is assembled in the head 7 of the ratchet wrench, and a C-clip 9 is engaged with the groove 12 of the socket 1 to position the socket 1. A cover 8 is mounted to the head 7 of the rats he wrench and the socket 1. extends through the cover 8.

Because the manufacturing tolerances are minimized and the hardness of the pawl 2 is high so that the socket 1 and the pawl 2 are able to output a high torque. The reinforcement portion 3 restricts the deformation of the socket 1 so that the method of the present invention has high yield rate.

While we have shown and described the embodiment in accordance with the present invention, it should be clear to those skilled in the art that further embodiments may be made without departing from the scope of the present invention.

What is claimed is:

1. A method for making a socket and a pawl of a ratchet wrench, comprising:
a step of preparing: preparing a socket with a through hole defined axially therethrough, and a pawl;
a step of first treatment: making the socket to have a body, a reinforcement portion and a driving hole, the driving hole defined axially through the body and having an axis, multiple ridges extending axially and inward from an inner periphery of the driving hole, the body having outer teeth formed on an outer periphery thereof the reinforcement portion being an annular portion and formed along one of two ends of the body, the socket being treated by way of forging, the pawl having a toothed portion and a recess respectively formed in two ends thereof, the toothed portion engaged with the outer teeth of the socket, the pawl being made by way of metal injection molding, and
a step of secondary treatment: polishing the socket and the pawl.

2. The method as claimed in claim 1, wherein a first thickness is defined between an outside face of the reinforcement portion and an inside face of the reinforcement portion, a second thickness is defined between a distal face of each ridge and the outer periphery of the body of the socket, the outside face of the reinforcement portion is in flush with the outer periphery of the body of the socket, the first thickness is larger than the second thickness.

3. The method as claimed in claim 1, wherein the reinforcement portion includes the outside face, the inside face and a top face which is formed between the outside face and the inside face, the inside face of the reinforcement portion communicates with the driving hole, an inclined face is formed between the inside face of the reinforcement portion and the inner periphery of the driving hole.

4. The method as claimed in claim 2, wherein the reinforcement portion includes the outside face, the inside face and a top face which is formed between the outside face and the inside face, the inside face of the reinforcement portion communicates with the driving hole, an inclined face is formed between the inside face of the rein portion and the inner periphery of the driving hole.

5. The method as claimed in claim 1, wherein an opening is formed within the reinforcement portion and located to share the axis of the driving hole as an axis of the opening, a diameter of the opening is smaller than that of the driving hole.

6. The method as claimed in claim 5, wherein a groove is formed in the outer periphery of the body of the socket and located between the outside face of the reinforcement portion and the outer periphery of the body of the socket, a depth of the groove in the radial direction of the socket is smaller than the first thickness.
